(19) United States
(12) Patent Application Publication
(10) Pub. No.: US 2025/0335580 A1
(43) Pub. Date: Oct. 30, 2025

(54) SYSTEM AND METHOD FOR IMMUTABILITY ASSURANCE OF BACKUP DATA BASED ON COMPREHENSIVE THREAT DETECTION

(71) Applicant: Acronis International GmbH, Schaffhausen (CH)

(72) Inventors: Nikolay Churkin, Istanbul (TR); Serg Bell, Costa del Sol (SG); Stanislav Protasov, Singapore (SG)

(21) Appl. No.: 18/647,457

(22) Filed: Apr. 26, 2024

(51) Int. Cl. G06F 21/54; G06F 21/56

(52) U.S. Cl. CPC G06F 21/54; G06F 21/563; G06F 21/565

(57) ABSTRACT

Systems and methods for immutability assurance of backup data based on comprehensive threat detection. A method includes performing static and dynamic analysis of a process executing on a computing device, registering an operation of the process with a file on a storage communicatively coupled to the computing device, determining that the file in operation is a backup archive, collecting a context of the process, which includes at least a security context based on the static and dynamic analysis, and a backup archive context based on attributes of the backup archive, analyzing the process operation with the backup file using an access control machine-learning model that calculates an immutability rate based on the collected context, and granting or blocking the process access to the backup archived.

### TECHNICAL FIELD

The invention relates generally to cybersecurity and data protection technologies. More particularly, the invention relates to systems and methods for the immutability of backup data through comprehensive threat detection, including the prevention of unauthorized modifications by malware.

### BACKGROUND

Cyber threats have evolved, with attackers developing malware that not only causes direct damage but also seeks to undermine recovery processes of information systems. Specifically, a category of attacks targets backup data to prevent recovery after an attack, thereby amplifying the impact of the breach.

Antimalware systems deploy a range of static and dynamic analysis techniques, including signature-based analysis and behavior analysis, to detect and neutralize malware threats. Traditional security systems aim to identify known malware patterns and monitor system behaviors for indications of malicious activity. However, known security solutions encounter significant challenges in detecting and preventing attacks that specifically target backup data for two main reasons. First, attackers employ zero-day exploits, leveraging vulnerabilities unknown to software vendors and, consequently, antimalware systems. The exploits allow malware to infiltrate systems undetected. Second, malware that mimics legitimate software poses a distinct challenge-it manipulates backup data under the guise of normal operations, making it challenging for antimalware systems to identify the malicious intent before the execution of harmful operations. By the time the attack is recognized, the backup data may have been altered or destroyed, leaving no option for system restoration.

Existing antimalware solutions may not adequately protect backup data against sophisticated threats that employ zero-day exploits or mimic legitimate processes to compromise data integrity. The limitations of traditional antimalware systems prove the need for an innovative approach to cybersecurity. Such an approach must effectively identify and mitigate threats targeting backup data, ensuring the preservation of data integrity in the face of sophisticated attacks.

### SUMMARY

Embodiments described or otherwise contemplated herein substantially meet the aforementioned needs of the industry. System and method for immutability assurance of backup data based on comprehensive threat detection provide process analysis, including both static and dynamic evaluations, with advanced machine learning techniques, ensuring that only authorized processes can operate with backup archives and backup data segments, depending on a calculated immutability rate that reflects the process trustworthiness and the potential risk to the data integrity.

In an embodiment, a computer implemented method for immutability assurance of backup data based on comprehensive threat detection comprises performing static analysis and dynamic analysis of a process executing on the computing device. When an operation of the process with a file on a storage communicatively coupled to the computing device is registered, determining that the file is a backup archive. The method proceeds with collecting a context of the process, the context including at least a security context based on the static and dynamic analysis, and a backup archive context based on attributes of the backup archive; and analyzing the operation with the backup file using an access control machine-learning model that calculates an immutability rate based on the collected context. The access control machine-learning (ML) model is trained on aggregated contexts of a plurality of previously-collected testing process samples, including security contexts and backup archive contexts. The access for operation of modification of the backup archive is granted, if the immutability rate is within a predetermined threshold, or is the access to the backup archive is blocked, if the immutability rate exceeds the predetermined threshold, where the predetermined threshold is indicative of a likelihood that the process operation with the backup archive is authorized and does not pose a threat to the integrity of the backup archive.

In an embodiment, determining that the file is a backup archive comprises parsing the file according to predefined backup format definitions, which include analyzing file header information, file size, and file extension to confirm that the file structure and attributes are consistent with those of known backup archive formats.

In an embodiment, the method further comprises labeling data within the backup archive in accordance with backup archive structure and content type, wherein the labeling includes assigning a criticality level to the data, wherein labeled data is a part of the backup archive context.

In an embodiment, the method further comprises profiling the process based on a set of process attributes, including a process digital certificate, historical behavior, resource usage, and network activity, wherein the generated process profile is integrated into the context of the process, wherein the access control machine-learning model is further configured to calculates the immutability rate based on the process profile.

In one aspect, the access control machine-learning model is trained for each distinct process profile, and upon profiling a process, the specifically trained model for that profile is chosen to calculate the immutability rate such that each immutability rate is profile-specific and reflects unique attributes and historical behaviors of each process.

In one aspect, performing static analysis and dynamic analysis of a process includes examining executable code of the process before the executable code runs to identify known malicious patterns or vulnerabilities, and observing the behavior of the process in real-time as the process interacts with system resources, network connections, and other processes to detect malicious activities.

In one aspect, the security context includes at least one of outcomes of antivirus scans, malware detection verdicts, intrusion detection system alerts, firewall logs, vulnerability assessment verdicts, behavior analysis flags, security ratings based on the process actions compared to known threat patterns, or statistical analysis of security events related to the process.

In an embodiment, determining that the file corresponds to a backup archive includes identifying the file as part of a full-backup archive, an incremental backup archive, a local backup, or a cloud backup.

In an embodiment, the backup archive context includes at least one of the backup type, backup metadata, content data, indexing data, and integrity verification data.

In an embodiment, a system for immutability assurance of backup data based on comprehensive threat detection comprises a security module, a filter driver, a format recognition unit and an access control unit. Security module is configured to perform static analysis and dynamic analysis of a process executing on the computing device, providing a comprehensive security assessment of the process prior to and during its operation. Filter driver is configured to register an operation of the process with a file on a storage communicatively coupled to the computing device. Format recognition unit is configured to determine that the file is a backup archive. Access control unit incorporating an access control ML model is configured to collect a context of the process, including at least a security context derived from the security module static and dynamic analysis, and a backup archive context based on attributes of the backup archive identified by the format recognition unit; analyze the process operation with the backup file, calculating an immutability rate based on the collected context; grant the process access to modify the backup archive when the immutability rate is within a predetermined threshold, or block the process access to the backup archive when the immutability rate exceeds the predetermined threshold. The predetermined threshold indicates a likelihood that the process operation with the backup archive is authorized and does not pose a threat to the integrity of the backup archive. The access control ML model is trained on aggregated contexts of a plurality of previously-collected testing process samples, including security contexts and backup archive contexts.

In an embodiment, the format recognition unit is configured to parse the file according to predefined backup format definitions to determine that the file is a backup archive, which include analyzing file header information, file size, and file extension to confirm that the file structure and attributes are consistent with those of known backup archive formats.

In an embodiment, the format recognition unit is configured to label data within the backup archive in accordance with backup archive structure and content type, assigning a criticality level to the data as part of the backup archive context.

In an embodiment, the access control unit with the access control ML model is configured to profile the process based on a set of process attributes, integrating the generated process profile into the context of the process

In an embodiment, the access control ML model within the access control unit is specifically trained for each distinct process profile such that each immutability rate is profile-specific that reflects unique attributes and historical behaviors of each process.

In an embodiment, the security module is configured to perform static analysis by examining the executable code of the process to identify known malicious patterns or vulnerabilities, and dynamic analysis by observing the behavior of the process in real-time as it interacts with system resources, network connections, and other processes to detect any malicious activities.

In an embodiment, the format recognition unit is configured to identify the file as part of a full-backup archive, an incremental backup archive, a local backup, or a cloud backup.

In an embodiment, an access control device comprises at least one processor and memory operably coupled to the at least one processor; instructions that, when executed, cause the at least one processor to: implement an access control machine-learning model, collect a context of a process executing on a computing device, including at least a security context derived from a static analysis and a dynamic analysis, and a backup archive context based on attributes of a backup archive, analyze, with the access control ML model, the process operation with the backup archive, calculating an immutability rate based on the collected context, wherein the access control machine-learning model is trained on aggregated contexts of a plurality of previously-collected testing process samples, including the security contexts and the backup archive contexts; and grant the process access to modify the backup archive when the immutability rate is within a predetermined threshold, or block the process access to the backup archive when the immutability rate exceeds the predetermined threshold, where the predetermined threshold indicates a likelihood that the process operation with the backup archive is authorized and does not pose a threat to the integrity of the backup archive.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1A is a block diagram of a full backup archive structure, in accordance with an embodiment.

FIG. 1B is a block diagram of an incremental backup archive structure, in accordance with an embodiment.

FIG. 2A is a block diagram of a system for immutability assurance of backup data, in accordance with an embodiment.

FIG. 2B is a block diagram of a subsystem for ensuring the immutability of backup data, in accordance with an embodiment.

FIG. 3 is a functional diagram of an access control unit, in accordance with an embodiment.

FIG. 4 is a flowchart of a method for detecting and parsing a backup file to form a backup archive context, in accordance with an embodiment.

FIG. 5 is a flowchart of a method for forming a security context, in accordance with an embodiment.

FIG. 6 is a flowchart of a method for immutability assurance of backup data, in accordance with an embodiment.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION

In the domain of data management, specifically within the scope of backup file operations, control mechanisms are predicated on a fundamental understanding of the varying structures of backup archives. In one embodiment, the control system comprehends the entire data set encapsulated by a full backup, which offers a complete snapshot, needed for system recovery scenarios. In another embodiment, the control mechanism extends to incremental backups, which capture only the changes since the last backup point, thus ensuring efficiency by avoiding redundancy. Furthermore, the control system distinguishes between local backups, which are stored within the proximity of the organizational environment, and cloud backups, which reside on remote servers accessed via network connections. Such distinction is paramount as local and cloud backups each possess unique characteristics pertinent to access control, recovery, and data security protocols.

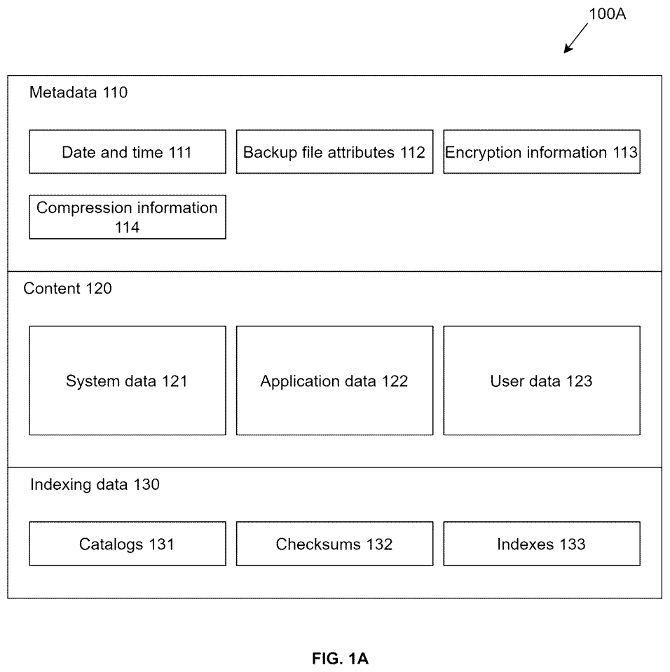

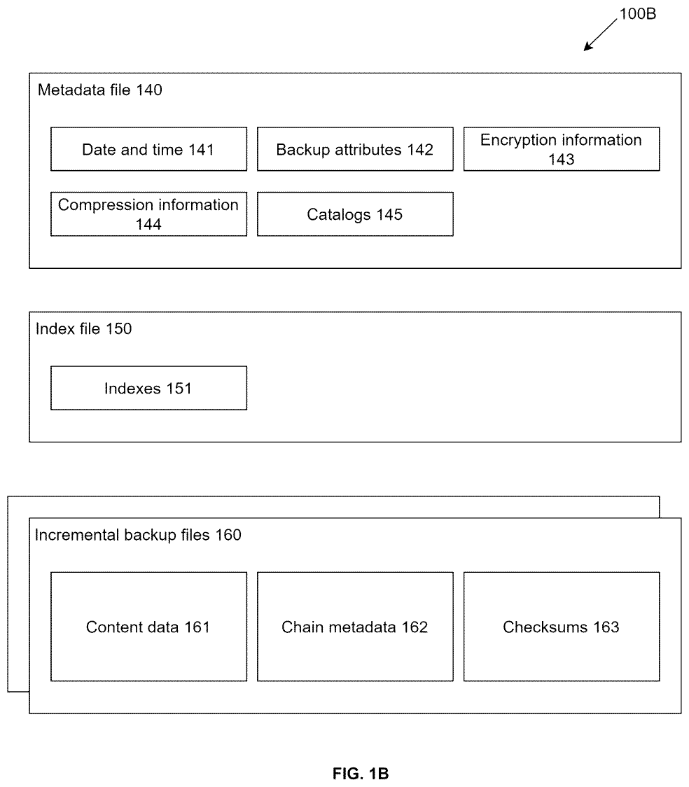

Referring to FIG. 1A, a block diagram of a full backup archive structure is depicted, according to an embodiment. The full backup typically comprises a single file 100A, which includes metadata, content, and indexing data. In one embodiment, a full backup file 100A structure is designed to fully restore a system state at the backup time. This file features a specific extension, such as .bak or .bkp, identifiable by both users and restoration software. The file begins with header information detailing the backup creation date, time, and software version, crucial for identifying and ensuring compatibility during restoration. The core of the backup file consists of compressed and potentially encrypted data blocks containing the actual backup data, employing algorithms based on user settings and software capabilities. File system metadata is also included for embodiments capturing entire disk images, detailing directory structures and permissions necessary for accurate restoration.

In an embodiment, Metadata 110 is a part of the backup file and serves as a repository of information that describes the characteristics of the backup file. Metadata 110 is divided into several components for detailed cataloging of backup attributes. Date and time 111 records the precise moment the backup was created, providing a temporal context. Backup file attributes 112 detail the backup file specifications, including size and file type. Encryption information 113 stores security measures applied to the backup data, such as encryption algorithms and key management, required for data privacy and compliance with security policies. Compression information 114 includes the parameters or algorithms applied that are used to reduce the backup file size, a feature that optimizes storage utilization and could impact data restoration speed.

Content 120 is a part of the backup file 110A that stores content from the target computing device and includes computing device data for recovery, segmented into distinct categories, each category housing different data types within the backup. System data 121 comprises the operating system and system configuration files, which are necessary for full system recovery. Application data 122 includes executable files and associated data for installed applications, which are necessary for application-level restoration. User data 123 includes personal or business-related data files, highlighting the user-specific aspect of the backup, which is often the focus of data integrity and recovery efforts.

Furthermore, in some backup systems, indexing data 130 is added to the backup file 100A to simplify the process of search or partial data recovery. Indexing data 130 can include catalogs 131 that function akin to a table of contents, listing and organizing the backed-up items to facilitate rapid location during restoration operations. Checksums 132 provide a mechanism for integrity verification, ensuring the fidelity of the backup when it is restored. Indexes 133 enable quick search capabilities within the backup file, which are particularly useful when specific items within a large dataset need to be accessed or restored.

Each block within FIG. 1A is shown to highlight that backup archives are not only comprehensive in their data inclusion but also streamlined for efficient parsing and control during backup file operations, according to an embodiment.

Referring to FIG. 1B, an incremental backup structure 100B is depicted, where multiple files work in conjunction to store and protect only the new or altered data since the last backup. In one embodiment, a metadata file 140 for an incremental backup, identifiable by a specific extension, organizes data changes since the last backup. It includes header information detailing the incremental backup's creation date, software version, and linkage to the previous backup, ensuring correct sequence restoration. The file 140 lists changed files and directories with details like paths, sizes, modification times, and attribute changes, and other data blocks, enabling precise restoration. The metadata file 140 documents the compression and encryption statuses, including utilized algorithms, facilitating accurate data decompression and decryption during restoration. Utilization of metadata file 140 optimizes the management and efficiency of incremental backups, ensuring streamlined restoration processes.

Date and time information 141 provides the specific moment the backup was executed. Backup attributes 142 detail the incremental file unique properties, including backup jobs, backup settings and other. Encryption information 143 describes the security protocols governing data protection. Compression information 144 includes the data reduction techniques used, which are essential for storage efficiency. Catalogs 145 maintain a record of the incremental changes for facilitating quick data retrieval.

Index file 150 stores indexes 151, a component that serves to swiftly locate changes within the expansive dataset of an incremental backup, contrasting with a full backup where the entire dataset would be indexed. In one embodiment, the index file 150 for an incremental backup, marked by a distinct extension, outlines the backup contents. Index file 150 starts with key information like creation date and linkage to the incremental backup, ensuring synchronization. The file lists changed items, detailing their names, locations, and metadata such as size and modification dates, enabling targeted restoration efforts. Entries of the index file 150 can be categorized for quicker access. Index file 150 simplifies navigating incremental backups, allowing for efficient data retrieval and integrity verification, enhancing the restoration process.

Incremental backup files 160 store the actual differential data in content data 161, capturing only the modifications since the last backup iteration. The body of the incremental backup file consists of data blocks representing the modified content since the last backup. Data blocks in incremental backup file 160 are compactly stored, typically employing compression to minimize storage space, and can be encrypted. Chain metadata 162 provides the linkage necessary for piecing together the entire backup series, ensuring chronological coherence. Chain metadata 162 links each backup or data block to its chronological neighbors, facilitating correct sequence restoration, data recovery efficiency, and integrity checks. Checksums 163 are employed to validate the integrity of the data at each incremental stage.

In an embodiment, the structure provided by backup structure 100B allows for meticulous control over backup operations, tailoring the backup process to be both resource-conscious and responsive to the dynamic nature of data within a system.

In the structure of backup archives as illustrated in FIG. 1A and FIG. 1B, specific attention is given to the integrity of the data components. Unauthorized or malicious modifications to particular elements of a backup file can lead to corruption or infection, rendering the backup ineffective for data recovery purposes.

In one embodiment, control mechanisms are in place to control metadata file 140.

Alteration of date and time information 141 could obfuscate the legitimate timeline of backup creation, potentially allowing for the insertion of corrupt data in place of the authentic backup data.

In another embodiment, encryption information 143 is controlled to prevent the injection of unauthorized encryption, which can render the backup inaccessible. For instance, malicious actors may alter the encryption information in an attempt to compromise the confidentiality and integrity of the backup, leading to a ransomware-like scenario where data becomes unreadable without the unauthorized encryption key.

Further, in another embodiment, compression information 144 is controlled to avoid unauthorized changes that could introduce corrupted data that, when decompressed, results in a compromised state of the backup, either through the introduction of malware or the destruction of valid data structures.

In yet another embodiment, checksums 163 within the backup archive serve as a bulwark against data integrity attacks. Any unauthorized modification of content, if undetected, could lead to the restoration of infected files, effectively spreading malware or corruption upon recovery.

Moreover, the integrity of catalogs 145 and indexes 151 is important in terms of data security. Any unsanctioned alterations to catalogs 145 and indexes 151 elements might not only mislead recovery efforts but could also direct restoration processes to infected or corrupted data locations within the backup.

According to an embodiment, backup data controls form an integral part of a comprehensive data protection strategy, allowing for the detection and prevention of backup file corruption or infection.

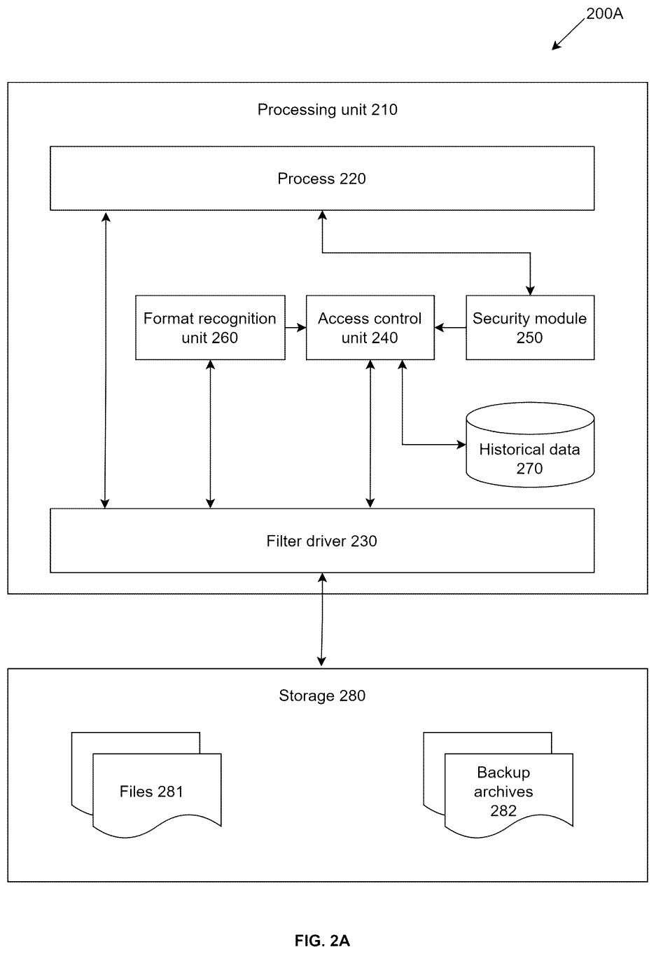

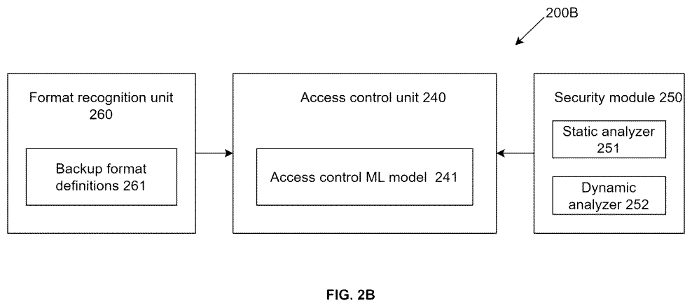

Referring to FIG. 2A, a block diagram of a system 200A for immutability assurance of backup data is depicted, in accordance with one embodiment, which incorporates comprehensive threat detection capabilities to safeguard backup archives.

A Processing unit 210 can be embodied by a variety of hardware configurations such as a personal computer, a mobile device, a server, or a microcontroller. On the processing unit 210, processes 220 operate continuously, interacting with files 281 stored on storage 280 with a file system. Upon execution, processes 220 perform a variety of operations such as read, write, and modify actions on file data. The file system, serving as an organizational framework, provides general information about each file. Information typically includes the file name, location in the catalog, size, and the structure of data blocks, among other attributes. In embodiments, memory can be operably coupled to the processing unit 210 and can store instructions that, when executed, cause the processing unit 210 to execute its components.

Each process 220 is monitored by a security module 250. In one embodiment, the security module 250 can be a software application utilizing known antivirus and antimalware algorithms to evaluate the behavior of process 220, determining if the process 220 behaves in a manner consistent with a set of threat characteristics.

To regulate the interaction of processes with files, particularly to safeguard the integrity and security of backups, a filter driver 230 is implemented. The filter driver 230 integrates into the storage operation stack, positioning itself to monitor and potentially alter the flow of read and write commands between the processes 220 and the storage medium (e.g. storage 280). Through integration of filter driver 230, the system 200A gains the capability to control all file operations, ensuring that only authorized actions are permitted. In an embodiment filter driver 230 is employed to control all input/output (I/O) operations on the storage 280, which might be either local or remote. The filter driver 230 can be a driver software that hooks into the operating system kernel to monitor and filter access requests to storage 280, ensuring that only authorized operations by validated processes are permitted.

When it comes to managing backup data, the system 200A can discern between regular files 281 and files constituting full or incremental backups 282. A differentiation process is accomplished by the format recognition unit 260, a component specifically tasked with identifying backup files 282 based on their structure and metadata. By analyzing file attributes and patterns indicative of backup data, such as specific file extensions, headers, or content structures—the format recognition unit 260 confirms the nature of the files in question.

Upon the identification of a file as a backup, whether full or incremental, the access control unit 240 combines a context of the process and backup file from security module 250 and format recognition unit 260 to analyze the operation of the process in regards the backup file operation and to grant or block access to the backup archive. In one embodiment, combined or collected context is processed as an input for access control ML model. In an embodiment, an access control unit 240 can collect additional context from the operating system of a computing device and/or filter driver 260. Access control unit 240 applies predefined rules or dynamic checks to determine whether a process should be allowed to modify the backup files. The goal is to ensure that backups remain immutable from unauthorized changes, thus preserving their integrity for when they are needed for data restoration or recovery. Through layered protections spanning from the low-level operations of the filter driver to the high-level assessments of the format recognition unit the system maintains a robust defense against potential data loss or corruption. The layered protection organization optimizes the utilization of computational resources. High-level computational tasks, particularly those associated with the format recognition unit, are selectively deployed based on the preliminary outcomes provided by other subsystems such as filter driver or dynamic analyzer. Layered protection organization ensures that resource-intensive analyses are conducted only when the initial, less complex calculations do not yield definitive classifications of a process operation regarding backup data. The system includes low-level operational controls within the dynamic analyzer, focusing on critical data operations indicative of unauthorized access or potential compromise. Operational controls facilitate the early detection and mitigation of risks, enhancing an ability to protect backup data effectively.

Historical data 270 can be a database or log file system that records all access attempts and modifications to backup archives 282, providing an audit trail for security operations and data for tuning or training access control unit 240.

System 200A presents a multifaceted approach to backup data protection, combining traditional security measures with advanced algorithms to provide a robust defense against unauthorized modifications or corruption of backup files. As described herein, each component contributes to a secure data backup environment.

Referring to FIG. 2B, a block diagram of a subsystem for ensuring the immutability of backup data 200B is depicted, in accordance with one embodiment. The Format recognition unit 260 uses backup format definitions 261 to separate backup files from regular data files. Format recognition unit 260 based on backup format definitions 261 matches files against predefined backup file characteristics, which can include unique file headers or specific data block configurations indicative of backup data. In certain instances, when backups are stored as disk images or compressed files, the format recognition unit 260 can engage procedures to mount the backup as a virtual disk or open a file using additional tools for analysis.

In another embodiment, the Format recognition unit 260 can leverage a machine learning (ML) model trained on a dataset including various backup file types (e.g. sourced from different vendors), as well as a contrasting dataset containing regular files. Such a ML-based format recognition approach allows for the classification of files, accurately distinguishing backup files as a unique class.

The Access control unit 240, in one embodiment, incorporates an access control ML model 241, which classifies access operations to backup files. Classification is informed by input that includes backup file attributes and data derived from a Security module 250. The security module 250 includes a static analyzer 251 and a dynamic analyzer 252. The static analyzer 251 assesses aspects of a process before execution, such as code structure, headers, and potential vulnerabilities, while the dynamic analyzer 252 scrutinizes runtime behaviors, security ratings, statistics, and patterns of connections and storage operations that may suggest malicious intent. ML models suitable for access control classification tasks include decision trees, support vector machines, or neural networks for format recognition, and implements ensemble methods like random forests or gradient boosting machines for access control for effective handling of complex classification problems.

The access control unit 240 integrates data inputs from both static and dynamic analyzers to form a comprehensive security context. Access control unit 240 then calculates a probability rate indicating whether a process interaction with a backup file is anomalous, potentially malicious, or legitimate. Based on the calculated probability rate, the access control unit 240 decides to either block or permit the process access to the backup, preventing unauthorized backup file modifications and ensuring the reliability of backup data for restoration purposes.

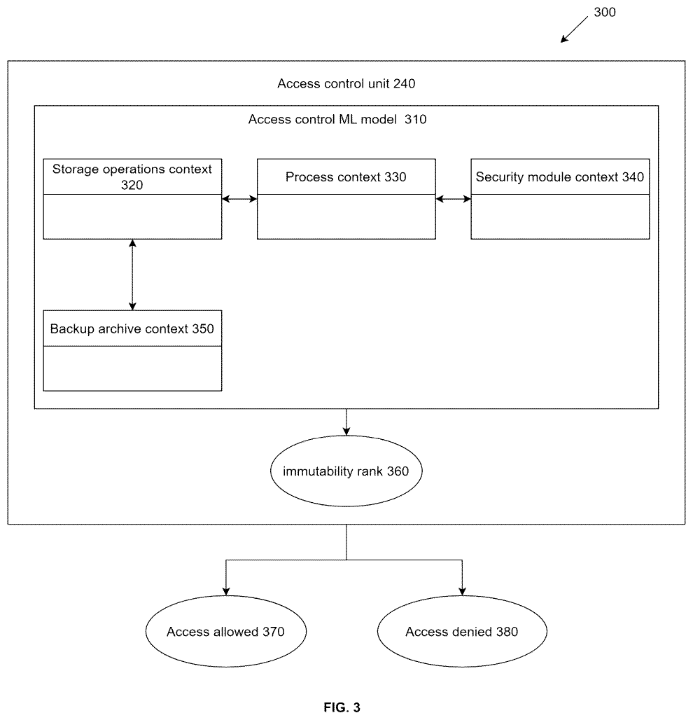

Referring to FIG. 3, a functional diagram 300 of an access control unit 240 is depicted, according to one embodiment. Access control unit 240 utilizes various contexts to compute an immutability rank that determines whether access to backup data should be granted or denied.

The Access control unit 240 is central to the diagram and includes an access control ML model 310. The access control ML model 310 processes input from several context sources to assess the risk associated with file operations on backup data.

The storage operations context 320 includes attributes that discern legitimate from potentially malicious activities, such as the frequency of file access requests, the size of data being read or written, the timing of operations relative to system events, and patterns that might match known ransomware behavior or unauthorized encryption attempts. Storage operations context 320 can include a wide array of attributes relevant to interactions with a storage system or disk, including backup files and other files related to a process:

File access frequency: how often a file is accessed within a given timeframe.

Read/write patterns: sequences and sizes of read and write operations, including random or sequential access patterns.

I/O request size: the size of input/output operations to the storage.

Timestamps: specific times when files are accessed, written, or modified.

File size changes: variations in the size of files over time, particularly sudden increases or decreases.

File type: an extension or format of files, such as .bak, .tar, .img, which may indicate backup data.

User ID/process ID: identifiers of the user or process initiating the storage operation.

Security descriptors: information related to the security attributes of a file, including

permissions.

Access rights: specific permissions granted to a file, such as read, write, execute.

File integrity flags: indicators or flags that suggest whether a file has been altered or tampered with.

Data transfer rates: speed at which data is written to or read from the storage.

Error rates: a frequency of read/write errors occurring during file operations.

Encryption flags: indicators showing whether a file is encrypted.

Archive bit: a file system attribute indicating whether the file has been backed up.

Storage media type: a type of storage media in use, such as SSD, HDD, or networked storage.

Logical/physical storage paths: pathways through which data is accessed on the storage system.

Buffering/caching behavior: a usage pattern of buffers or caches during file operations.

System calls invoked: specific system calls made by the process in relation to storage operations.

Network activity: any network interactions that occur during access to networked storage or cloud-based backups.

Queue length: the number of I/O operations waiting to be processed for a file or disk.

Each of listed attributes can provide insights into the nature of a process' interactions with storage and can help distinguish between legitimate and potentially malicious activities.

The security module context 340 incorporates data from security checks performed by both the static analyzer 251 and the dynamic analyzer 252 within the security module 250. Static and dynamic analyzers provide security verdicts, ratings, statistical analysis, stack behaviors, and event logs that are indicative of process integrity and potential threats. The list of attributes of security module context 340 can comprise:

Verdicts from security scanners: outcomes from antivirus scans, which can be “clean”, “infected”, or “suspicious”, indicating the perceived threat level of a process or file.

Event logs: detailed records of security events that have occurred, which can include login attempts, configuration changes, and file accesses.

Security ratings: scores assigned to processes or files based on their assessed level of risk.

Behavioral patterns: observations related to process behaviors that align with or deviate from expected patterns, which can include network requests, file modifications, or system interactions.

Statistical data: quantitative data points about system or network activity that can highlight anomalies or trends, such as an unusual number of read/write operations.

Security incident and event management (SIEM) alerts: notifications from SIEM systems that aggregate and analyze activity from many different resources across IT infrastructure.

User and entity behavior analytics (UEBA): insights that stem from monitoring and analyzing user behavior to detect anomalies that can indicate threats like insider attacks or compromised accounts.

Threat intelligence feeds: information from global databases on known threats, vulnerabilities, and attack methodologies, which can be used to compare against local system activity for potential matches.

Network traffic analysis: examination of inbound and outbound network traffic to detect suspicious patterns or communications with known malicious entities.

Alert disposition settings: configuration parameters that determine how aggressive the system is in flagging potential threats, which can influence the balance between false positives and false negatives.

File activity monitoring: tracking of file access and modifications, which can be used to detect unauthorized changes or access to sensitive data.

A backup archive context 350 contains detailed information about accessing backup files. Backup archive context 350 includes data characteristics such as file type, size, last modified timestamp, and entropy levels of the data, which can signal unusual changes or potential corruption. The content and structure of the backup data, including file hierarchy and the presence of expected metadata, are also evaluated. A list of attributes that make up the Backup archive context 350 can include the following attributes:

Backup type: identifying whether the file is a full or incremental backup, based on previously described structures.

File name and extension: The name and format of the backup file, which may indicate the software used to create it (e.g., .bkp, .bak, .tar).

File size: the overall size of the backup file, where a significant deviation from expected size can signal an anomaly.

Timestamps: creation, modification, and last accessed dates and times that can be compared against expected backup schedules.

File header information: specific signatures or markers within the file header that designate the file as a backup.

Data block structure: organization and sequence of the data blocks within the file, which should conform to known backup formats.

Content summary: high-level description of what data is included, such as system files, user data, application data, etc.

Data criticality labels: classifications assigned by the format recognition unit, indicating the sensitivity or importance of the data (e.g., confidential, public, internal).

Compression and encryption status: information on whether the backup is compressed and/or encrypted, including the type of encryption or compression algorithm used.

Checksums and hashes: values used for integrity checks that can reveal if the backup has been altered since its creation.

Change logs: records of any alterations made to the backup file since its last confirmed secure state.

Access patterns: historical data regarding how the backup file is typically accessed, against which current access patterns can be compared.

Entropy levels: measures of randomness within the file data, where unusually high or low entropy can indicate encryption or corruption.

Data redundancy checks: identifiers that suggest whether the backup contains duplicate information, potentially indicating data integrity issues.

Process context 330 includes a variety of attributes, which can be sourced from the operating system or directly from the attributes of the process itself. A detailed list of attributes included in process context 330 includes:

Digital certificates: certificates attached to the process, which authenticate the source and integrity of the executing code.

Process history: historical log data of the process activities, including previous actions and interactions with system resources.

Executable file attributes: metadata of the process executable file, such as file size, creation date, version, and publisher.

Process ID (PID): a unique identifier assigned by the operating system to the process.

Parent-child process tree: a hierarchy or chain of processes that have spawned the current process, which can indicate whether a legitimate application initiated the process.

Memory usage: amount of memory the process is consuming, with abnormal usage potentially indicating malicious activity.

CPU usage: level of CPU resources the process is utilizing, where excessive or minimal usage can be indicative of abnormal behavior.

I/O read and write operations: intensity and pattern of the process read and write operations on the system storage.

Network activity: details on the network operations initiated by the process, such as opened ports, destination IP addresses, and the volume of data transferred.

API calls: system and library calls made by the process, which can reveal access attempts to sensitive functions or system resources.

Runtime behavior: observations on how the process behaves during execution, which can include interaction with user input, system services, or other applications.

Error logs: records of the process failure events, exceptions, or other error outputs that can signal malfunctioning or potentially malicious code.

Privilege level: level of permissions granted to the process, with higher privileges warranting stricter scrutiny due to the potential for system-wide changes.

File paths accessed: specific directories and files that the process attempts to access, particularly sensitive system and user data locations.

Command line arguments: parameters and arguments passed to the process on startup, which can specify operational modes or actions.

Using context sources, the access control ML model 310 calculates an immutability rank 360. Rank is a probabilistic assessment of whether the operation by a given process on backup data is legitimate, suspicious, or outright malicious. Based on the computed immutability rank, the access control decision is made, leading to either access allowed 370 or access denied 380 outcomes.

In one embodiment, the access control unit 240 includes an access control ML model 241 configured to first establish a profile of the process in question. Profiling is an initial operation, wherein the access control ML model 241 analyzes the process context 330, incorporating attributes such as digital certificates, historical behavior, resource usage, and network activity, to determine the nature and typical behavior patterns of the process. In one embodiment, each process running on a computing device exhibits a unique pattern of behavior and characteristics, which can be defined and stored within a process profile. Process profiles are constructed based on a comprehensive analysis of the process attributes, including but not limited to its execution history, resource consumption patterns, network activities, and digital certificate validity. To accommodate the diverse nature of processes, the method employs not a singular, one-size-fits-all ML model 310 but a suite of models, each trained specifically to the nuances of a different process profile. The training methodology ensures that the ML models are finely tuned to recognize the subtleties in behavior and risk associated with their respective profiles.

When a process initiates an operation that interacts with backup files, the static analyzer 251 or any other system unit that performs the initial process check, first identifies the process profile. Access control unit 240 selects the ML model 310 that has been specifically trained for the profile. The selected model then proceeds to analyze the process operation in the context of the backup archive, calculating an immutability rate-a quantitative measure of the operation conformity to expected behavior and its potential threat to the backup integrity.

The profile-specific calculation allows for a highly refined assessment of risk, with the immutability rate reflecting the unique risk factors associated with the profile of the process in question.

Once the profile is established, the access control unit 240 then assesses the operations that the process is attempting to perform on the backup files. Assessment takes into account not only the process profile but also the collected context from Storage operations context 320, security module context 340, and backup archive context 350. By integrating context data sources, the access control ML model 241 can more accurately evaluate whether the process actions align with legitimate backup file operations or if the process actions deviate in a manner that suggests potential risks, warranting intervention to ensure the immutability and integrity of the backup data.

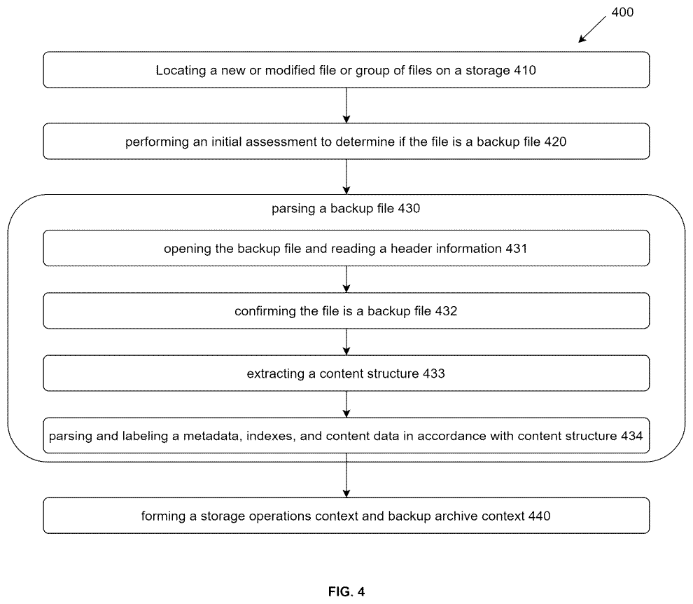

Referring to FIG. 4, a flowchart of a method 400 for the detecting and parsing of a backup file to form a backup archive context is depicted, according to an embodiment. The process 400 initiates at 410 by locating a new or modified file or group of files on a storage device. Locating includes scanning the storage medium to identify files that have been newly created or altered since the last check. Operation 410 can be implemented using file system monitoring tools or services that track changes in real-time, providing a list of potentially new backup files. Filter driver 230 can perform operation 410, in one embodiment.

At 420, an initial assessment to determine if the file is a backup file is performed, assessing the identified files to ascertain if they conform to backup file characteristics. Initial assessment 420 includes checking the file extension, size, or modified dates against expected norms for backup files. The technical output of operation 420 is a subset of files that are likely to be backups.

At 430, the potential backup file is parsed, the method delves deeper into the file content, beginning with opening the backup file and reading header information 431. The file is accessed, and the header information, which often contains metadata about the file content and structure, is extracted. Tools like hex editors or specialized backup inspection utilities can implement operation 430. Format recognition unit 260 performs parsing in one embodiment.

At 432, the system confirms that the file is a backup file. The confirmation is based on the header information matching known backup file signatures or formats. The result is a verification status indicating whether the file is indeed a backup.

Once confirmed, the method 400 proceeds to extracting a content structure 433, where the internal organization of the backup file is analyzed. Backup file organization analysis can include unpacking any compression and reading directory structures or file lists within the backup.

At 434, the parsed data is organized and labeled based on its role and content. For instance, metadata relating to backup integrity checks is separated from the actual file content. The labeling can be handled by format recognition unit 260 designed to recognize and categorize different data types within the backup file.

The final operation forms a storage operations context and backup archive context 440. The storage operations context encapsulates how the backup files are being handled on the storage medium, while the backup archive context includes the parsed and labeled backup file data. Storage operations and backup archive context serve as inputs for systems designed to protect and manage backup file integrity, providing a comprehensive understanding of the backup state and facilitating informed access control decisions.

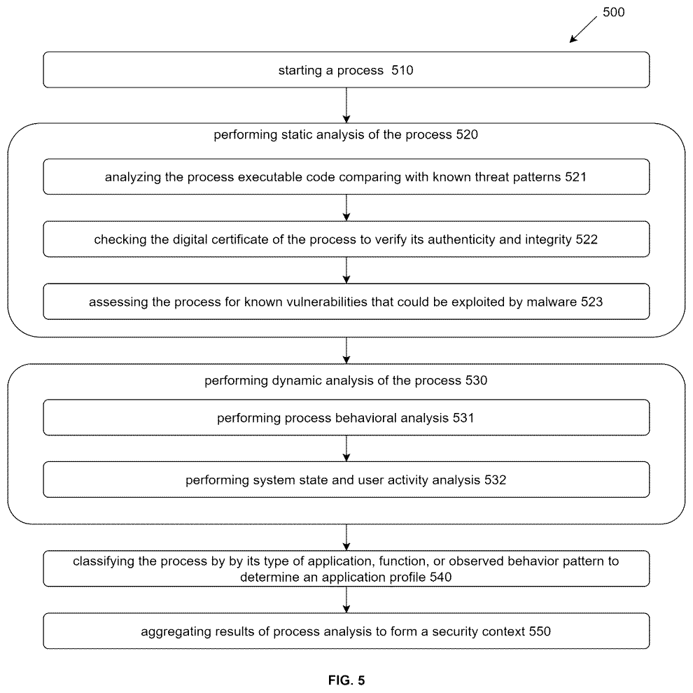

Referring to FIG. 5, a flowchart of a method 500 for forming a security context is depicted according to an embodiment. In particular, method 500 depicts the operations involved in evaluating and profiling a computing process.

The method 500 begins at 510 with starting a process, where the process is initiated on the computing device. Process start can include running an application, a system service, or any executable task. The initiation of a process is the precursor to security evaluation.

Following the start, static analysis of the process is initiated at 520. Static analysis 520 involves analyzing the process executable code compared with known threat patterns 521 to identify potential risks before the risks manifest during execution. Security tools such as signature-based antivirus programs can be employed to match code against databases of known malware signatures.

Checking the digital certificate of the process to verify its authenticity and integrity 522 is the next operation. Checking action at 522 ensures that the process originates from a reputable source and has not been tampered with. Certificate validation software can validate the signatures against certificate authority records.

In assessing the process for known vulnerabilities that can be exploited by malware at 523, vulnerability scanners can be utilized to scrutinize the process for outdated software or known security weaknesses that can provide entry points for attackers.

The method 500 proceeds with performing dynamic analysis of the process 530. Dynamic analysis 530 includes performing process behavioral analysis 531, which observes the real-time actions of the process to detect any anomalous behavior that can indicate a security threat. Additionally, performing system state and user activity analysis 532 is part of dynamic analysis 530, which includes monitoring the overall health of the system and user interactions that could affect process behavior.

Classifying the process by its type of application, function, or observed behavior pattern to determine an application profile is performed at 540. Classification systems can analyze the purpose of the process, such as whether the process is a web browser, a word processor, or custom enterprise software, and establish an operational profile based on observed behaviors and attributes.

Finally, the method 500 concludes in aggregating results of process analysis to form a security context 550. A comprehensive profile includes all data collected in the previous operations and serves as a foundation for security decisions. By integrating the static and dynamic analysis results with process classifications, a robust security context is formulated that can inform access controls, threat detection, and response strategies.

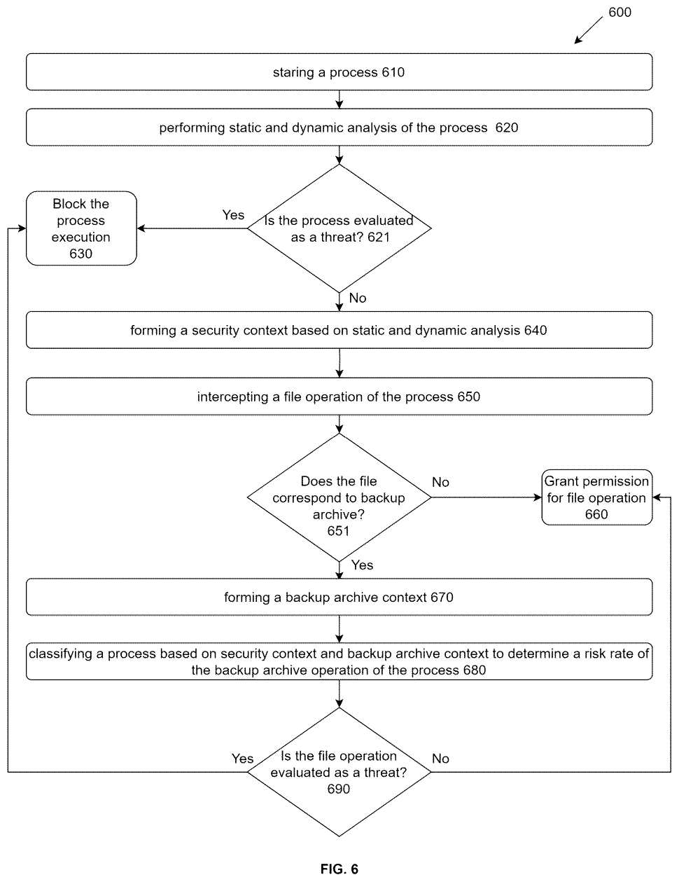

Referring to FIG. 6, a flowchart of a method 600 for immutability assurance of backup data is presented, according to an embodiment. The method 600 starts at 610 with starting a process, where a computing device initiates a process that could potentially interact with backup files.

At 620, static and dynamic analyses of the process are performed. Static and dynamic analysis involves evaluating the process in real-time and comparing its characteristics against known threat models to ascertain any potential risk before the process can interact with backup files.

At 621, the process is evaluated for being a threat. If the analysis at 620 deems the process as a threat, the flow proceeds to 630, where the process execution is blocked to prevent any potentially harmful interaction with the backup files.

At 640, forming a security context based on static and dynamic analyses is performed if the process is not identified as a threat. The security context integrates the findings from the initial analyses to create a profile of the process behavior and intentions.

At 650, a file operation of the process is obtained, serving as a checkpoint for any actions the process attempts to perform on files, particularly those operations that can modify data. File operations can be intercepted by system drivers, provided by the operating system, or read from log of file operations. All file operations are registered in access control unit 240 or security module 250.

At 651, the method 600 assesses if the attempting file corresponds to a backup archive. Operation 651 is needed for determining if the intercepted file operation is related to backup data, which requires heightened security measures.

If the file operation pertains to a backup archive, the process advances to 670, where forming a storage operations context and backup archive context is performed. Operation 670 synthesizes information about how the file is stored, accessed, and the specific nature of the backup data being handled.

At 680, classifying a process based on security context and backup archive context to determine a risk rate of the backup archive operation of the process is conducted. Classification uses the security context and the backup archive context to evaluate the potential risk associated with the process intended operation on the backup file.

Finally, at 690, the method 600 determines if the file operation is evaluated as a threat. If the risk rate, referred to as immutability rate, calculated at 680 indicates a potential threat, the file operation is blocked to protect the immutability of the backup data. Otherwise, if no threat is detected, the process moves to 660, where permission for the file operation is granted, allowing the process to interact with the backup file as intended.

In one embodiment of the method for assuring the immutability of backup data, upon assigning a suspicious immutability rate to a process actions, access control unit 240 or or security module 250 promptly generates a shadow copy of the affected backup. A shadow copy represents a restorable version of the backup data, safeguarding its integrity prior to any actions taken by the process under evaluation. Duplication is typically facilitated by volume snapshot services that can efficiently create a copy without significant impact on system resources. If subsequent analysis confirms that the process in question is indeed malicious, the system is prepared to revert the backup to its previous state, utilizing the preserved shadow copy to restore the data to its condition before the unauthorized access.

The system also includes capabilities for ongoing surveillance of process interactions with backup files. If a process displays behavior patterns that deviate from established norms, suggesting a threat, access control unit 240 or security module 250 can either restrict the process activities or halt the process entirely to mitigate any potential risk.

Additionally, if process interactions with backup files raise concerns, access control unit 240 or security module 250 can enact protocols to relocate the backup data to a more secure location within the storage infrastructure. Backup relocation restricts further access to the data until the system can perform additional checks to confirm the legitimacy of the process actions.

Access permissions for backup files are dynamically managed, allowing access control unit 240 or security module 250 to adjust permissions in real-time based on the evolving security context. Dynamic adjustment ensures that only processes that pass stringent security verification are able to interact with backup data.

Moreover, the access control unit 240 or security module 250 alert security personnel when unusual interactions with backup files are detected. Alerting allows for quick human intervention, which is required when dealing with sophisticated threats that automated systems may not fully mitigate.

In the event of a confirmed malware detection, access control unit 240 or security module 250 invokes a predefined incident response protocol, which can include isolating the compromised system from the network to prevent the spread of the threat and performing comprehensive scans to identify and address any additional breaches.

In an embodiment, the system incorporates a comparative analysis feature that functions as an additional layer of security for backup immutability assurance. The analysis operates by comparing the modified data within the backup with the current state of the corresponding original files present on the system.

When a process performs an operation that modifies backup data, access control unit 240 or security module 250 retrieves the current state of the original files from the live system data. Access control unit 240 or security module 250 compares two data sets to determine whether the modifications in the backup accurately reflect changes that have occurred within the system normal data flow. Comparative analysis is predicated on the expectation that legitimate modifications to backup data should be congruent with updates to the original files, such as those resulting from regular system use or scheduled updates.

If the comparative analysis reveals discrepancies between the modified backup data and the current state of the system original files, such as alterations that have no corresponding updates or changes that are out of sync with the system known operations, a divergence can be indicative of unauthorized or anomalous behavior. Such inconsistencies may suggest that the backup modification is not a result of legitimate system activity but potentially a result of unauthorized access, configuration errors, or a malicious attempt to alter the backup data stealthily.

In an embodiment, the access control unit 240 is designed to grant partial access for the modification of backup data based on the comprehensive profile of the process and the contextual information surrounding the backup operation. Access control mechanisms are tailored to provide differential access rights to various segments of the backup data, ensuring that only permissible modifications are made while safeguarding critical data elements.

For instance, the process profile, developed from a thorough analysis of the process historical behavior and its current operations, informs the access control unit 240 about the trustworthiness and intent of the process. If the profile and associated security context indicate that the process is legitimate but with certain limitations, the access control unit 240 can allow the process to modify user data content within the backup-such as documents or settings personalized by the user-while restricting the process from altering metadata which can include information such as backup timestamp, file size, and the integrity checksums. The metadata is often essential for the verification and restoration processes, and thus, its integrity is paramount.

Moreover, the access control unit 240 can differentiate content within the backup based on labels assigned by the format recognition unit. For example, content labeled as ‘Confidential’ or as

‘Executable Files’ can be protected more stringently. The access control unit 240 can prohibit any modifications to labeled data segments due to their sensitivity or potential to affect system operations, respectively. Conversely, content labeled as ‘User Data’ may be deemed less critical, and thus, the process may be granted the permissions to modify labeled segments under the condition that such modifications are consistent with the process profile and operational context.

Selective permission strategy balances the need for system functionality and user autonomy with the overarching imperative of data protection. By allowing partial modifications, the system maintains the integrity of the most critical backup data segments while accommodating necessary updates to less critical data, ensuring that the backup remains both up-to-date and secure. The level of access granted to a process is directly influenced by this profile, with more trustworthy processes receiving broader permissions. Access permissions are calibrated against the criticality level of the backup data segments. In one embodiment, the system categorizes process permissions into at least two levels based on the process security profile and the criticality of the backup data segments. The first level of permission, assigned to processes with a moderate track record of secure operations, allows for modifications to non-sensitive backup data segments, such as user-generated documents or non-critical system settings. For example, permissible operation of updating user documents within the backup without the ability to alter system configuration files. The second level of permission, assigned to processes that have demonstrated exemplary security compliance, grants access to more sensitive data segments within the backup. For example, granted access to update system configuration files additional to user-generated documents or non-critical system settings. However, even at this level, the most sensitive data, such as encryption keys or system recovery information, remains off-limits or subject to additional verification processes before modifications are allowed.

In one embodiment of a method for training an Access Control ML model 310, the training data includes an aggregated context including storage operations, security assessments, and backup content characteristics, including the security contexts and the backup archive contexts, collected for testing process samples. Testing process samples may represent a collection of executable files of secure and malicious software, or testing process samples can comprise records of testing process execution logs, or testing process samples can be implemented as a database or storage where the context of the target process operation in a required point of time, can be obtained. The ML model 310 is trained to recognize patterns within a context that are indicative of legitimate or malicious access attempts to backup data.

The training strategy can include supervised learning, where the ML model 310 is presented with historical context data that has been labeled as either benign or malicious. The labeled data acts as a reference for the ML model 310 to learn the distinguishing features associated with each class. Supervised learning algorithms such as logistic regression, decision trees, or neural networks can be applied, each chosen for their ability to handle high-dimensional data and produce an accurate classification based on the complex context attributes.

In another embodiment, semi-supervised learning can be employed when there is a mixture of labeled and unlabeled context data. Semi-supervised learning leverages the labeled instances to understand the underlying structure of the data and makes predictions about the unlabeled instances, which can then be included in the training set to refine the model further. Algorithms suitable for semi-supervised learning strategy can involve self-training classifiers or co-training approaches, where two or more models mutually improve their predictions using the unlabeled data.

Furthermore, an unsupervised learning approach can be implemented, which involves clustering techniques to identify patterns and structures within the context data without pre-labeled instances. The ML model 310 can use algorithms such as k-means clustering or hierarchical clustering to group similar context data together, potentially revealing insights into unknown or emerging types of backup access attempts.

In a further embodiment, reinforcement learning can be applied to train the Access Control ML model 310. In the reinforcement learning approach, the model learns through interactions with the environment by taking actions and observing the outcomes in terms of rewards or penalties. Reinforcement learning strategy is beneficial in dynamic systems where backup access patterns may evolve over time.

Each training strategy focuses on leveraging the rich context data to build a robust and adaptive ML model capable of accurately assessing backup file access operations. The trained Access Control ML model 310 can then compute an immutability rank that aids in the decision-making process of allowing or blocking access to backup data.

1. A computer implemented method for immutability assurance of backup data based on comprehensive threat detection comprising:
performing static analysis and dynamic analysis of a process executing on the computing device;
registering an operation of the process with a file on a storage communicatively coupled to the computing device;
determining that the file is a backup archive;
collecting a context of the process, the context including at least a security context based on the static and dynamic analysis, and a backup archive context based on attributes of the backup archive;
analyzing the operation with the backup file using an access control machine-learning model that calculates an immutability rate based on the collected context as an input, wherein the access control machine-learning model is trained on aggregated contexts of a plurality of previously-collected testing process samples, including security contexts and backup archive contexts; and
granting the process access to modify the backup archive when the immutability rate is within a predetermined threshold, or blocking the process access to the backup archive when the immutability rate exceeds the predetermined threshold, wherein the predetermined threshold is indicative of a likelihood that the process operation with the backup archive is authorized and does not pose a threat to the integrity of the backup archive.

2. The method of claim 1, wherein determining that the file is a backup archive comprises parsing the file according to predefined backup format definitions, which include analyzing file header information, file size, and file extension to confirm that the file structure and attributes are consistent with those of known backup archive formats.

3. The method of claim 1, further comprising labeling data within the backup archive in accordance with backup archive structure and content type, wherein the labeling includes assigning a criticality level to the data, wherein labeled data is a part of the backup archive context.

4. The method of claim 1, further comprising profiling the process based on a set of process attributes, including a process digital certificate, historical behavior, resource usage, and network activity, wherein the generated process profile is integrated into the context of the process, wherein the access control machine-learning model is further configured to calculate the immutability rate based on the process profile.

5. The method of claim 4, wherein the access control machine-learning model is trained for each distinct process profile, and upon profiling a process, the specifically trained model for that profile is chosen to calculate the immutability rate such that each immutability rate is profile-specific and reflects unique attributes and historical behaviors of each process.

6. The method of claim 1, wherein performing static and dynamic analysis of a process includes examining executable code of the process before the executable code runs to identify known malicious patterns or vulnerabilities, and observing the behavior of the process in real-time as the process interacts with system resources, network connections, and other processes to detect malicious activities.

7. The method of claim 1, wherein the security context includes at least one of outcomes of antivirus scans, malware detection verdicts, intrusion detection system alerts, firewall logs, vulnerability assessment verdicts, behavior analysis flags, security ratings based on the process actions compared to known threat patterns, or statistical analysis of security events related to the process.

8. The method of claim 1, wherein determining that the file corresponds to a backup archive includes identifying the file as part of a full-backup archive, an incremental backup archive, a local backup, or a cloud backup.

9. The method of claim 1, wherein the backup archive context includes at least one of the backup type, backup metadata, content data, indexing data, and integrity verification data.

10. A system for immutability assurance of backup data based on comprehensive threat detection, the system comprising:
a security module, configured to perform static analysis and dynamic analysis of a process executing on the computing device, providing a comprehensive security assessment of the process prior to and during its operation;
a filter driver, configured to register an operation of the process with a file on a storage communicatively coupled to the computing device;
a format recognition unit, configured to determine that the file is a backup archive;
an access control unit incorporating an access control machine-learning model, configured to:
collect a context of the process, including at least a security context derived from the security module static and dynamic analysis, and a backup archive context based on attributes of the backup archive identified by the format recognition unit,
analyze the process operation with the backup file, calculating an immutability rate based on the collected context,
grant the process access to modify the backup archive when the immutability rate is within a predetermined threshold, or block the process access to the backup archive when the immutability rate exceeds the predetermined threshold, where the predetermined threshold indicates a likelihood that the process operation with the backup archive is authorized and does not pose a threat to the integrity of the backup archive;
wherein the access control machine-learning model is trained on aggregated contexts of a plurality of previously-collected testing process samples, including security contexts and backup archive contexts.

11. The system of claim 10, wherein the format recognition unit is further configured to parse the file according to predefined backup format definitions to determine that the file is a backup archive, which include analyzing file header information, file size, and file extension to confirm that the file structure and attributes are consistent with those of known backup archive formats.

12. The system of claim 10, wherein the format recognition unit is further configured to label data within the backup archive in accordance with backup archive structure and content type, assigning a criticality level to the data as part of the backup archive context.

13. The system of claim 10, wherein the access control unit with the access control ML model is further configured to profile the process based on a set of process attributes, integrating the generated process profile into the context of the process.

14. The system of claim 12, wherein the access control ML model within the access control unit is specifically trained for each distinct process profile such that each immutability rate is profile-specific that reflects unique attributes and historical behaviors of each process.

15. The system of claim 10, wherein the security module is further configured to perform static analysis by examining the executable code of the process to identify known malicious patterns or vulnerabilities, and dynamic analysis by observing the behavior of the process in real-time as it interacts with system resources, network connections, and other processes to detect any malicious activities.

16. The system of claim 10, wherein the security context includes at least one of outcomes of antivirus scans, malware detection verdicts, intrusion detection system alerts, firewall logs, vulnerability assessment verdicts, behavior analysis flags, security ratings based on the process actions compared to known threat patterns, or statistical analysis of security events related to the process.

17. The system of claim 10, wherein the format recognition unit is configured to identify the file as part of a full-backup archive, an incremental backup archive, a local backup, or a cloud backup.

18. The system of claim 10, wherein the backup archive context includes at least the backup type, backup metadata, content data, indexing data, and integrity verification data.

19. An access control device comprising:
at least one processor and memory operably coupled to the at least one processor;
instructions that, when executed, cause the at least one processor to:
implement an access control machine-learning model,
collect a context of a process executing on a computing device, including at least a security context derived from a static analysis and a dynamic analysis, and a backup archive context based on attributes of a backup archive,
analyze, with the access control ML model, the process operation with the backup archive, calculating an immutability rate based on the collected context, wherein the access control machine-learning model is trained on aggregated contexts of a plurality of previously-collected testing process samples, including the security contexts and the backup archive contexts; and
grant the process access to modify the backup archive when the immutability rate is within a predetermined threshold, or block the process access to the backup archive when the immutability rate exceeds the predetermined threshold, where the predetermined threshold indicates a likelihood that the process operation with the backup archive is authorized and does not pose a threat to the integrity of the backup archive.

20. The access control device of claim 19, wherein the instructions that, when executed, cause the at least one processor to further profile the process based on a set of process attributes to generate a process profile, integrating the generated process profile into the context of the process.
